(19) United States
(12) Patent Application Publication
(10) Pub. No.: US 2005/0146097 A1
(43) Pub. Date: Jul. 7, 2005

(54) Tool holder for a power tool

(76) Inventors: Manfred Hellbach, Leinfelden-Echterdingen (DE); Gerhard Meixner, Filderstadt (DE)

Correspondence Address: STRIKER, STRIKER & STENBY, 103 EAST NECK ROAD, HUNTINGTON, NY, 11743, US

(21) Appl. No.: 11/005,067

(22) Filed: Dec. 6, 2004

(30) Foreign Application Priority Data
Dec. 20, 2003 (DE) 103 60 077.9

(51) Int. Cl. B25D 9/00

(52) U.S. Cl. 279/19.1; 173/132

(57) ABSTRACT

The present invention is directed to a tool holder for a power tool, in particular for a drilling hammer or a chipping hammer, with a cavity (72) for receiving tools (12), a grooved shank (16), and at least one radially displaceable locking body (24, 50), which is insertable in a locking groove (22) of tool (12) and is closed on the shank end (20), and which is capable of being held in its locked position by a locking element (30, 58).

It is proposed that, to create a large contact surface (40, 56), the locking body (24, 50) is positioned with its longitudinal axis (42, 54) at an angle (α, β) to a longitudinal axis (18) of the cavity (72).

### BACKGROUND OF THE INVENTION

The present invention is directed to a tool holder for a power tool according to the definition of the species of Claim 1.

A percussion power tool with a rotationally driven tool holder is known from EP 0 456 003 B1. Tools with a grooved shank can be held in the tool holder. The tool holder has a radially displaceable locking body in the form of a ball positioned parallel to the longitudinal axis of the groove, which is insertable in a groove of the tool—the groove being closed on the shank end—and which is held in its locked position by a locking sleeve movable within limits, and a retaining sleeve.

Balls provide just one point-like contact surface on the tool which engages quickly.

### SUMMARY OF THE INVENTION

The present invention is directed to a tool holder for a power tool, in particular for a drilling hammer or a chipping hammer, with a cavity for receiving tools, with a grooved shank and at least one radially displaceable locking body which is insertable in a locking groove of the tool which is closed on the shank end and which is capable of being held in its locked position by a locking element.

It is proposed that, to create a large contact surface, the locking body is positioned with a longitudinal axis at an angle to a longitudinal axis of the cavity. The longitudinal axis of the cavity corresponds to a longitudinal axis of the shank end of a tool to be inserted. By way of a longitudinal contour of the locking body, a locking body positioned at an angle to the locking groove can be optimally matched to a contour of the locking groove of an inserted tool. The contact area can be larger that that of a ball. The locking body can be positioned diagonally to the longitudinal axis of the cavity, whereby the locking body can be oriented diagonally to the cross section of the cavity, so that, in the circumferential direction, at least one portion of the locking body is located on a periphery of the cavity. The locking body is preferably positioned with its longitudinal extension at least partially tangential to the circumference of the cavity. This allows the locking of the tool to be simplified. The tool holder can be manufactured more economically while providing a reliable means of locking the tool. To this end, a matching groove can be provided in the tool holder. Due to the longitudinal contour, the locking body is also held securely in a deep locking groove of the tool. The tool holder therefore has a tolerance in terms of permissible depths of the locking groove. Due to the tangential orientation of the locking body, a compact arrangement can be created which functions without additional overall height, as compared to a ball with a diameter comparable to a transverse extension of the locking body which is perpendicular to the longitudinal axis.

If the locking element for holding the locking body in the locked position is formed by a retaining ring, the locking body can be prevented from falling out. The retaining ring is preferably supported on a rod on an interior side of a sliding sleeve capable of being actuated from the outside. The arrangement is simple and reliable.

According to a second preferred embodiment, the longitudinal axis of the locking body is positioned at an acute angle with the longitudinal axis of the cavity. Via the arrangement of the locking body, it can be optimally matched to the locking groove of the inserted tool. Inserting and removing the tool is simplified. The locking body can lock the tool by way of self-locking forces resulting from the diagonal insertion. The tool cannot be thrust outwardly.

The flattest and most stable contact possible between locking body and locking groove can be achieved when an end face of the locking body is configured, at least partially, as a radial and axial contact surface.

If the locking body is displaceably supported in a guide body, a secure retention of the locking body can be created. The guide body preferably has a guide surface which matches the angle. The locking body can glide radially outwardly and inwardly on this guide surface. Means for rotationally securing the locking body are advantageously provided to obtain a favorable contact surface of the locking body with the locking groove of the inserted tool. The shape of the guide surface is preferably matched to the contour of the locking body.

The locking body can be designed in the shape of a cylinder, which is particularly favorable for the first and second embodiment. The locking body can also be designed with an angular contour, e.g., a trihedron or square; this is particularly favorable for the second embodiment.

### BRIEF DESCRIPTION OF THE DRAWINGS

Further advantages result from the following description of the drawing. Two exemplary embodiments of the present invention are depicted in the drawing. The drawing, description, and claims contain numerous features in combination. One skilled in the art will also advantageously consider them individually and combine them to form further reasonable combinations.

FIG. 1 shows a preferred power tool,

FIG. 2 shows a longitudinal view through an arrangement according to a first embodiment with a tangentially bearing locking body,

FIG. 3 shows a cross section through the arrangement according to FIG. 2,

FIG. 3a shows a section of a schematic top view according to FIG. 2,

FIG. 4 shows a longitudinal sectional view through an arrangement according to a second embodiment with a diagonally positioned locking body,

FIG. 5 shows a cross section through the arrangement according to FIG. 4.

### DESCRIPTION OF THE PREFERRED EMBODIIMENTS

In the figures, parts that remain essentially the same are always labelled with the same reference numerals.

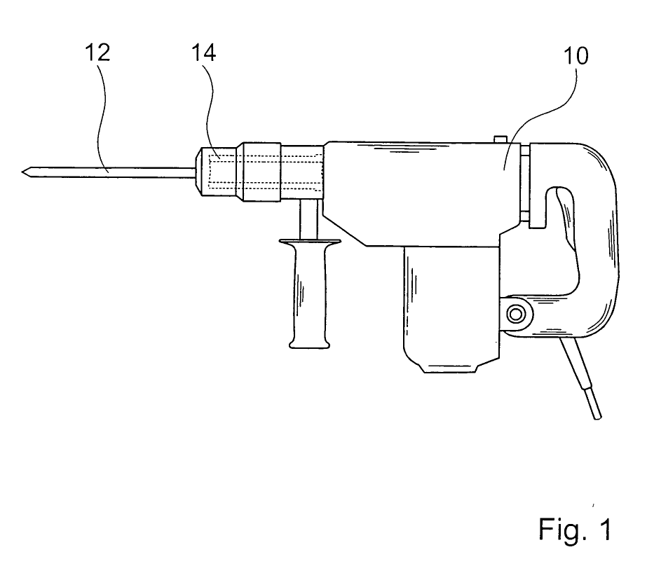

FIG. 1 shows a power tool 10, in particular a drilling hammer or a chipping hammer, with a tool holder 14 for receiving tools 12. Tool 12 with a locking groove 22 closed on shank end 20 is locked by a locking body 24.

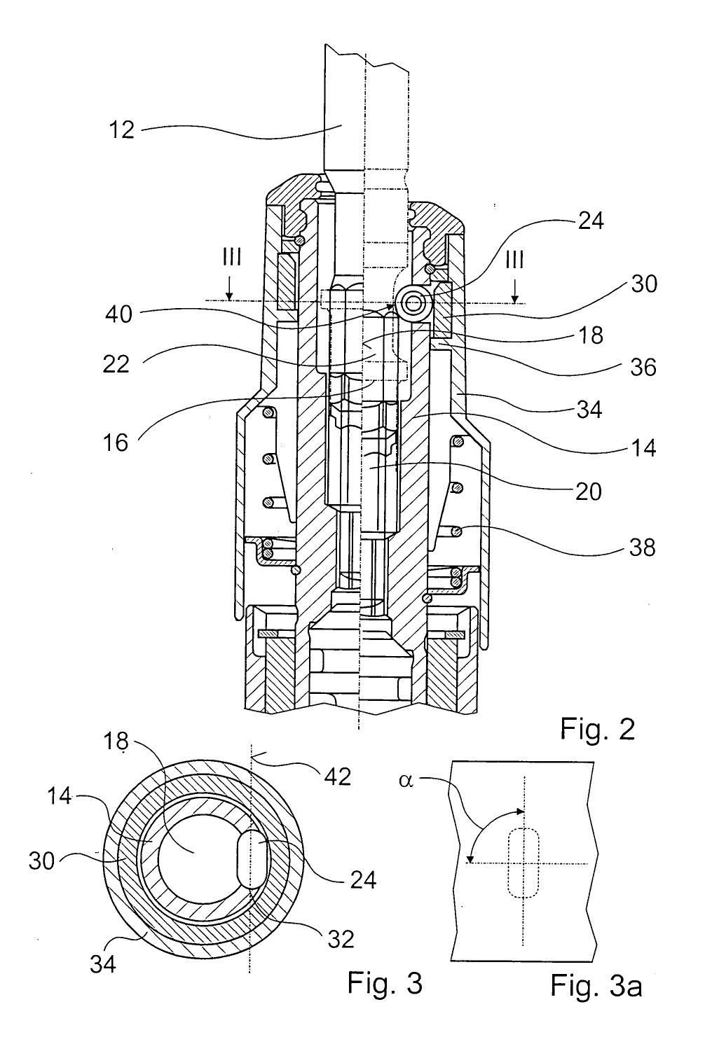

FIG. 2 shows a sectional view through an arrangement according to a first embodiment of the present invention. A tool 12 with a grooved shank 16 has a closed locking groove 22 on a shank end 20 and is held in a cavity 72 of a tool holder 14. A longitudinal, radially displaceable locking body 24 designed in the shape of a cylinder is located in cavity 72, the locking body being insertable in a locking groove 22 of tool 12 and which is held in its locked position by a locking element 30 designed as a retaining ring.

Locking body 24 has a contact surface 40 on locking groove 22. A longitudinal axis 42 of locking body 24 is positioned at an angle α=90° to a longitudinal axis 18 of cavity 72, which coincides with the longitudinal axis of a tool shank, whereby locking body 24 is positioned, in its locked position, tangentially to a periphery of cavity 72 and bears against locking groove 22.

Locking element 30, which is designed as a retaining ring, is supported on a rod 36 on an interior side of a sliding sleeve 34 which is capable of being actuated from the outside.

To unlock and lock, locking element 30 configured as retaining ring is retracted by pulling sliding sleeve 34 back against the spring force of a spring 38. Locking body 24 can then move radially outwardly and release tool 12. If tool 12 is fully inserted, locking body 24 engages in locking groove 22 and locks the tool when locking element 30 designed as a retaining ring is pushed over locking body 24 by releasing sliding sleeve 34 using the spring force of spring 38.

FIG. 3 shows a top view of the arrangement. Longitudinal axis 42 of locking body 24 is perpendicular to longitudinal axis 18 of tool 12, which is perpendicular to the plane of the drawing, and locking body 24 configured as a cylinder bears tangentially against locking groove 22. Locking body 24 is located in a groove 32 of tool holder 14.

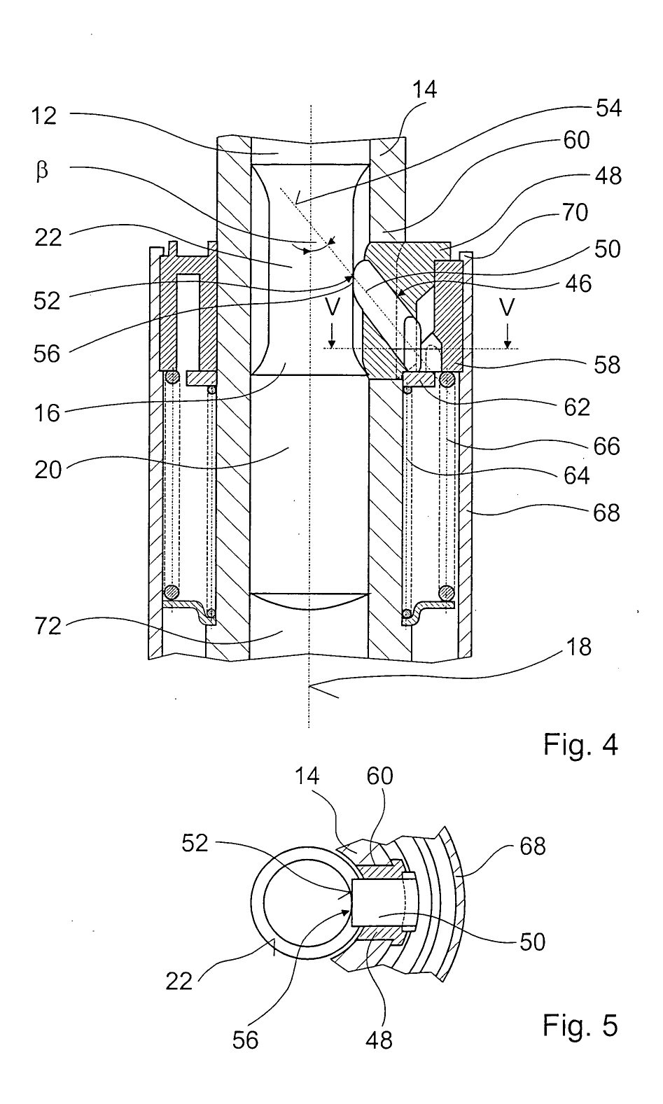

FIG. 4 shows a preferred second embodiment of the present invention. A tool 12 with a grooved shank 16 has a closed locking groove 22 on one shank end 20, and is held in a cavity 72 of a tool holder 14. A longitudinal axis 18 of cavity 72 coincides with the longitudinal axis of the tool shank or cavity 72. A longitudinal axis 54 of a locking body 50 configured in the shape of a rod is positioned at an acute angle β with longitudinal axis 18 of locking groove 22, whereby the angle β opens toward shank end 20. Locking body 50 points, with an end face 52, to a periphery of cavity 72 and bears against locking groove 22 with end face 52. Locking body 50 is displaceably supported in a guide body 48, which has a guide surface 46 which matches angle β and is diagonal in design.

When tool 12 is inserted, locking body 50 is pushed radially outwardly in the direction of the slant and allows tool 12 to pass. When tool 12 is fully inserted, a spring 64 pushes locking body 50 via a ring 62 into the locked position.

If a sliding sleeve 68, which is capable of being actuated from the outside, is retracted, it carries a locking element 58 along with it, the locking element being pressed against a rod 70 of sliding sleeve 68 via spring force of a spring 66. Guide body 48 is therefore released. It can be pushed radially outwardly in a groove 60 of tool holder 14 and thereby release tool 12.

Advantageously, means, which are not shown, are provided to secure locking body 50 against rotation. If longitudinal locking body 50 is designed with an angular configuration, guide surface 46 can also surround locking body 50 with a matching contour and thereby secure it against rotation.

FIG. 5 shows a top view of a cross section of the arrangement according to FIG. 4. Locking body 50 bears with an end face 52 on locking groove 22 against contact surface 56. Guide body 48 is located in a groove 60 of tool holder 14 and surrounds locking body 50.

1. A tool holder for a power tool, in particular for a drilling hammer or a chipping hammer, with a cavity (72) for receiving tools (12), a grooved shank (16), and at least one radially displaceable locking body (24, 50), which is insertable in a locking groove (22) of tool (12) and is closed on the shank end (20), and which is capable of being held in its locked position by a locking element (30, 58),
wherein, to create a large contact surface (40, 56), the locking body (24, 50) is positioned with its longitudinal axis (42, 54) at an angle (α, β) to a longitudinal axis (18) of the cavity (72).

2. The tool holder as recited in claim 1,
wherein the locking body (24) is positioned with its longitudinal extension at least partially tangential to the circumference of the cavity (72).

3. The tool holder as recited in claim 1,
wherein the locking element (30) for holding the locking body (24) in the locked position is formed by a retaining ring.

4. The tool holder as recited in claim 3,
wherein the retaining ring is supported on a rod (36) on the inside of a sliding sleeve (34) capable of being actuated from the outside.

5. The tool holder as recited in claim 1,
wherein the longitudinal axis (54) of the locking body (50) is positioned at an acute angle (β) to a longitudinal axis (18) of the cavity (72).

6. The tool holder as recited in claim 5,
wherein an end face (52) of the locking body (50) is configured, at least partially, as a radial and axial contact surface.

7. The tool holder as recited in claim 5,
wherein the locking body (50) is displaceably supported in a guide body (48).

8. The tool holder as recited in claim 7,
wherein the guide body (48) has a guide surface (46) which matches angle (β).

9. The tool holder as recited in claim 5,
wherein at least one means for rotationally securing the locking body (50) is provided.

10. The tool holder as recited in claim 1,
wherein the locking body (24, 50) is designed in the shape of a cylinder.

11. The tool holder as recited in claim 1,
wherein the locking body (24, 50) is designed with an angular contour.

12. A power tool, in particular a drilling hammer or a chipping hammer, with a tool holder (14) with a cavity (72) for receiving tools (12), a grooved shank (16) which has at least one radially displaceable locking body (24, 50), which is insertable in a locking groove (22) of tool (12) and is closed on the shank end (20), and which is capable of being held in its locked position by a locking element (30, 58).
